(19) United States
(12) Patent Application Publication
(10) Pub. No.: US 2018/0306041 A1
(43) Pub. Date: Oct. 25, 2018

(54) MULTIPLE TURBINE VANE FRAME

(71) Applicant: General Electric Company, Schenectady, NY (US)

(72) Inventors: Andreas Peters, Munich (DE); Vittorio Michelassi, Scandicci (IT); Paul H. Vitt, Liberty Township, OH (US)

(21) Appl. No.: 15/496,685

(22) Filed: Apr. 25, 2017

(51) Int. Cl. F01D 9/04

(52) U.S. Cl. CPC F01D 9/041; F05D 2220/32; F05D 2240/20; F05D 2240/14; F05D 2240/12

(57) ABSTRACT

A turbine vane frame apparatus includes: an annular inner band disposed about a centerline axis and defining an inner flowpath surface; an annular outer band surrounding the inner band and defining an outer flowpath surface; and an array of axial-flow airfoil-shaped vanes disposed between the inner and outer flowpath surfaces, wherein the vanes have at least three different chord dimensions.

### BACKGROUND OF THE INVENTION

This invention relates generally gas turbine engines, and more particularly relates to stationary airfoil frames in such engines.

A gas turbine engine includes, in serial flow communication, a compressor, a combustor, and a high-pressure turbine. The high-pressure turbine is mechanically coupled to the compressor and the three components define a turbomachinery core. The core is operable in a known manner to generate a flow of hot, pressurized combustion gases to operate the engine as well as perform useful work such as providing propulsive thrust or mechanical work.

One form of gas turbine engine known as a turbofan adds to the core a low-pressure system comprising a low-pressure turbine positioned downstream of the high-pressure turbine. The low-pressure turbine mechanically drives a fan used for producing thrust.

A turbofan may include a flowpath component referred to as a turbine center frame which includes a plurality of structural elements surrounded by straight, non-turning aerodynamic fairings. The turbine center frame serves the functions of both providing structural support, housing oil and cooling flow piping, and directing flow discharged from a high-pressure turbine into a downstream low-pressure turbine at appropriate flow conditions. The turbine center frame is typically followed by the nozzle vanes of the first stage of the low-pressure turbine in conventional turbofan architectures. These vanes turn the flow to provide appropriate inflow conditions for the rotor of the first stage of the low-pressure turbine.

One problem with existing with existing configurations of turbine center frame plus a separate first stage low-pressure turbine nozzle is that they are heavy, large, and complex. One solution is to combine the functions of the turbine center frame and first stage low-pressure turbine nozzle into a single component, referred to as a turbine vane frame. In this solution, the structural elements in the flowpath component between high- and low-pressure turbine are surrounded by turning airfoils which direct the flow discharged from the high-pressure turbine directly into a downstream first stage low-pressure turbine rotor. A separate row of vanes upstream of the low-pressure turbine rotor is no longer required, enabling engine length and weight savings as well as reducing complexity. One problem associated with the turbine vane frame concept is that the flow turning required by the aerodynamic fairings is typically large, on the order of 50 to 80 degrees, making the flow prone to separate, leading to severe performance penalties. High turning also results in high velocities locally, potentially resulting in compression shocks which may penalize the performance of downstream components.

### BRIEF DESCRIPTION OF THE INVENTION

This problem is addressed by a multiple turbine vane frame having a stator vane row including turning vane airfoils. The turbine vane frame serves the functions of both providing structural support and directing flow discharged from a high-pressure turbine into a downstream low-pressure turbine at appropriate flow conditions, so that a separate turbine nozzle is not required.

According to one aspect of the technology described herein, a turbine vane frame apparatus includes: an annular inner band disposed about a centerline axis and defining an inner flowpath surface; an annular outer band surrounding the inner band and defining an outer flowpath surface; and an array of axial-flow airfoil-shaped vanes disposed between the inner and outer flowpath surfaces, wherein the vanes have at least three different chord dimensions.

### BRIEF DESCRIPTION OF THE DRAWINGS

The invention may be best understood by reference to the following description taken in conjunction with the accompanying drawing figures in which:

FIG. 1 is a half-sectional, schematic view of a gas turbine engine that incorporates a turbine vane frame;

FIG. 2 is a partially-sectioned side view of a portion of a turbine vane frame along with a pair of turbine rotors;

FIG. 3 is a view taken along lines 3-3 of FIG. 2;

FIG. 4 is a view taken along lines 4-4 of FIG. 3;

FIG. 5 is a sectional view of a portion of an alternative turbine vane frame;

FIG. 6 is a partially-sectioned side view of a portion of the turbine vane frame along with a pair of turbine rotors;

FIG. 7 is a view taken along lines 7-7 of FIG. 6;

FIG. 8 is a view taken along lines 8-8 of FIG. 7;

FIG. 9 is a sectional view of a portion of an alternative turbine vane frame;

FIG. 10 is a sectional view of a portion of an alternative turbine vane frame;

FIG. 11 is a view taken along lines 11-11 of FIG. 10;

FIG. 12 is a view taken along lines 12-12 of FIG. 10; and

FIG. 13 is a view taken along lines 13-13 of FIG. 10; and

FIG. 14 is a front elevational view of the turbine vane frame of FIG. 10.

### DETAILED DESCRIPTION OF THE INVENTION

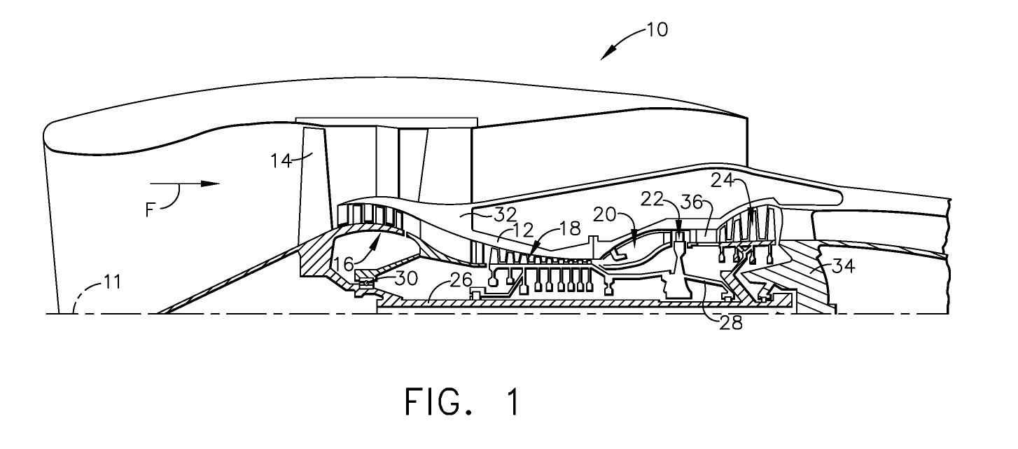

Referring to the drawings wherein identical reference numerals denote the same elements throughout the various views, FIG. 1 depicts an exemplary gas turbine engine 10. While the illustrated example is a high-bypass turbofan engine, the principles of the present invention are also applicable to other types of engines, such as low-bypass turbofans, turbojets, turboprops, etc. The engine 10 has a longitudinal center line or axis 11 and an outer stationary annular core casing 12 disposed concentrically about and coaxially along the axis 11.

It is noted that, as used herein, the terms “axial” and “longitudinal” both refer to a direction parallel to the centerline axis 11, while “radial” refers to a direction perpendicular to the axial direction, and “tangential” or “circumferential” refers to a direction mutually perpendicular to the axial and radial directions. As used herein, the terms “forward” or “front” refer to a location relatively upstream in an air flow passing through or around a component, and the terms “aft” or “rear” refer to a location relatively downstream in an air flow passing through or around a component. The direction of this flow is shown by the arrow “F” in FIG. 1. These directional terms are used merely for convenience in description and do not require a particular orientation of the structures described thereby.

The engine 10 has a fan 14, booster 16, compressor 18, combustor 20, high pressure turbine or “HPT” 22, and low pressure turbine or “LPT” 24 arranged in serial flow relationship. In operation, pressurized air from the compressor 18 is mixed with fuel in the combustor 20 and ignited, thereby generating combustion gases. Some work is extracted from these gases by the high pressure turbine 22 which drives the compressor 18 via an outer shaft 28. The combustion gases then flow into the low pressure turbine 24, which drives the fan 14 and booster 16 via an inner shaft 26. The inner and outer shafts 26 and 28 are rotatably mounted in bearings 30 which are themselves mounted in a fan frame 32 and a turbine rear frame 34.

The engine 10 incorporates a turbine vane frame 36 disposed between the high pressure turbine 22 and the low pressure turbine 24. The purpose of the turbine vane frame 36 is to redirect direct flow exiting the high pressure turbine 22 and deliver it to the inlet of the low pressure turbine 24 with appropriate flow conditions (e.g. pressure, velocity, tangential velocity).

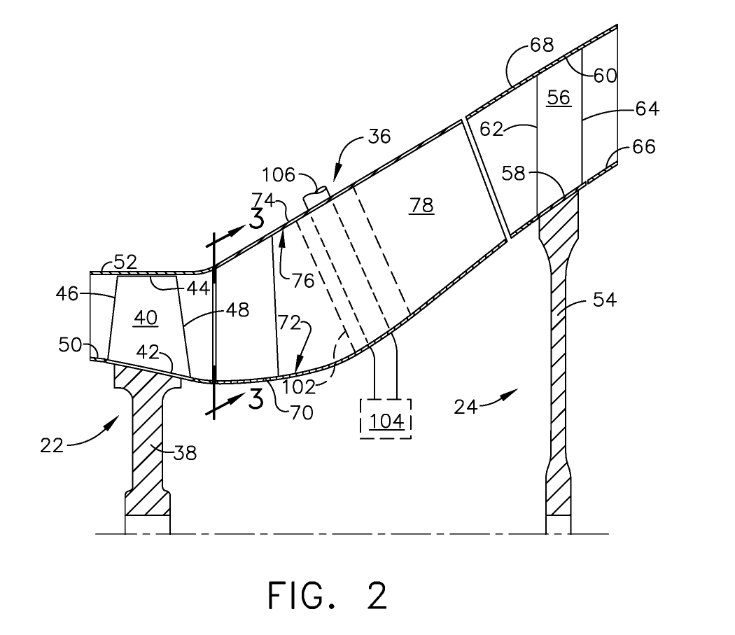

FIGS. 2, 3, and 4 illustrate an exemplary embodiment of the turbine vane frame 36, along with portions of the high pressure turbine 22 and the low pressure turbine 24.

The HPT 22, located immediately upstream of the turbine vane frame 36, includes a rotor disk 38 carrying array of turbine blades 40. Each turbine blade 40 extends from a root 42 to a tip 44, and includes opposed concave and convex sides joined at a leading edge 46 and a trailing edge 48. The flowpath through the HPT 22 is bounded by an inner wall 50 and an outer shroud 52.

The LPT 24, located immediately downstream of the turbine vane frame 36, includes a rotor disk 54 carrying array of turbine blades 56. Each turbine blade 56 extends from a root 58 to a tip 60, and includes opposed concave and convex sides joined at a leading edge 62 and a trailing edge 64. The flowpath through the LPT 24 is bounded by an inner wall 66 and an outer shroud 68.

The turbine vane frame 36 includes an annular inner band 70 that defines an annular inner flowpath surface 72, and an annular outer band 74 that surrounds the inner band 70 and defines an annular outer flowpath surface 76. In the illustrated example, the outer band 74 may be an integral portion of the core casing 12 shown in FIG. 1.

An array of stationary airfoil-shaped turning vanes (or simply “vanes”) extend between the inner band 70 and the outer band 74. In the illustrated example, the vanes are of three distinct configurations referred to respectively as first vanes 78, second vanes 80, and third vanes 82. The complete array of turning vanes comprises a repeating pattern of the first, second, and third vanes around the periphery of the turbine vane frame 36. It will be understood that this configuration is merely an example, and the number of vanes in the repeating pattern and their specific aerodynamic configuration may be varied to suit a particular application. The structural aspects of each of the discrete vane configurations will be described in further detail below.

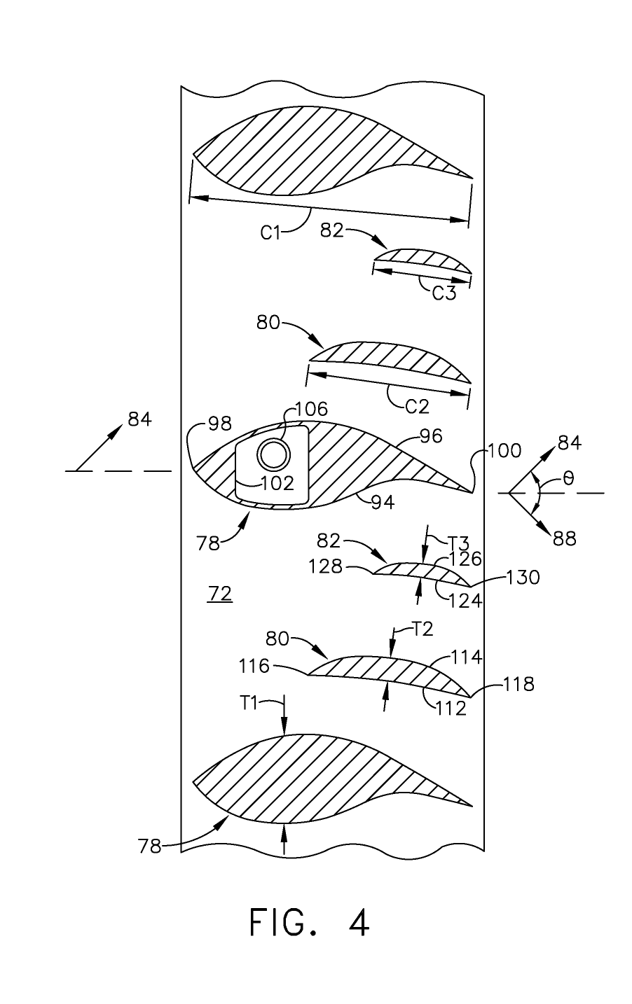

The first, second, and third vanes 78, 80, and 82 are configured to produce a particular degree of turning of the flow in the tangential direction as required by the aerodynamic design of the engine 10. This tangential flow turning is illustrated schematically in FIG. 4 wherein a first flow vector 84 is shown at an inlet of the turbine vane frame 36, and a second flow vector 88 is shown at an outlet of the turbine vane frame 36. The angle θ between the first and second flow vectors 84 and 88 characterizes the degree of flow turning. The turbine vane frame 36 is configured so as to produce a high degree of flow turning, defined herein as turning the flow through an angle of at least 50°, and preferably 50° to 70°.

Each of the first vanes 78 extends from a root 90 at the inner flowpath surface 72 to a tip 92 at the outer flowpath surface 76, and includes a concave pressure side 94 joined to a convex suction side 96 at a leading edge 98 and a trailing edge 100.

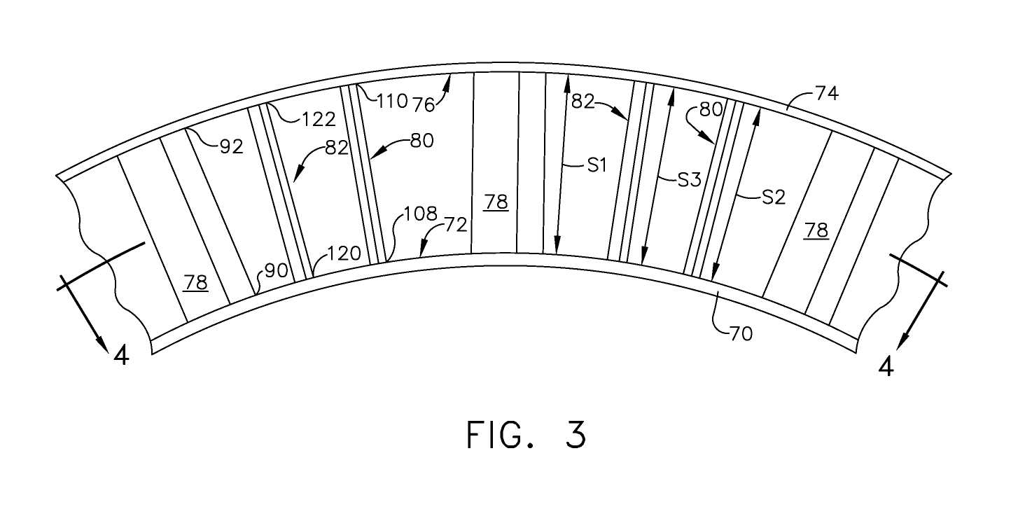

Each of the first vanes 78 has a span (or span dimension) “S1” (FIG. 3) defined as the radial distance from the root 90 to the tip 92. Depending on the specific design of the first vanes 78, its span S1 may be different at different axial locations. For reference purposes, the relevant measurement would be the span S1 at the leading edge 98. Each first vane 78 has a chord (or chord dimension) “C1” (FIG. 4) defined as the length of an imaginary straight line connecting the leading edge 98 and the trailing edge 100. Depending on the specific design of the first vanes 78, its chord C1 may be different at different locations along the span S1. For purposes of the present invention, the relevant measurement would be the chord C1 at the root 90 or tip 92.

Each of the first vanes 78 has a thickness “T1” defined as the distance between the pressure side 94 and the suction side 96 (see FIG. 4). A “thickness ratio” of the first vane 78 is defined as the maximum value of the thickness T1, divided by the chord length, expressed as a percentage.

In addition to serving as aerodynamic turning elements, the first vanes 78 are sized and configured so as to support structural loads applied to the turbine vane frame 36 during engine operation. The first vanes 78 are also sized to serve as pass-through elements as described below. In order to serve these functions, the first vanes 78 may have a significant thickness over and above that required for flow turning purposes. For example, the first vanes 78 may be about 30% to 40% thick.

At least some of the first vanes 78 may incorporate a hollow interior cavity 102. The function of this interior cavity 102 is to allow one or more service tubes to pass therethrough. “Service tubes” includes structures such as pipes, ducts, or other conduits used to transfer fluid such as oil, fuel, bleed air, etc. between the area inboard of the turbine vane frame 36 (e.g. an oil sump 104) and the area outboard of the turbine vane frame 36. An exemplary service tube 106 is shown schematically in FIG. 2.

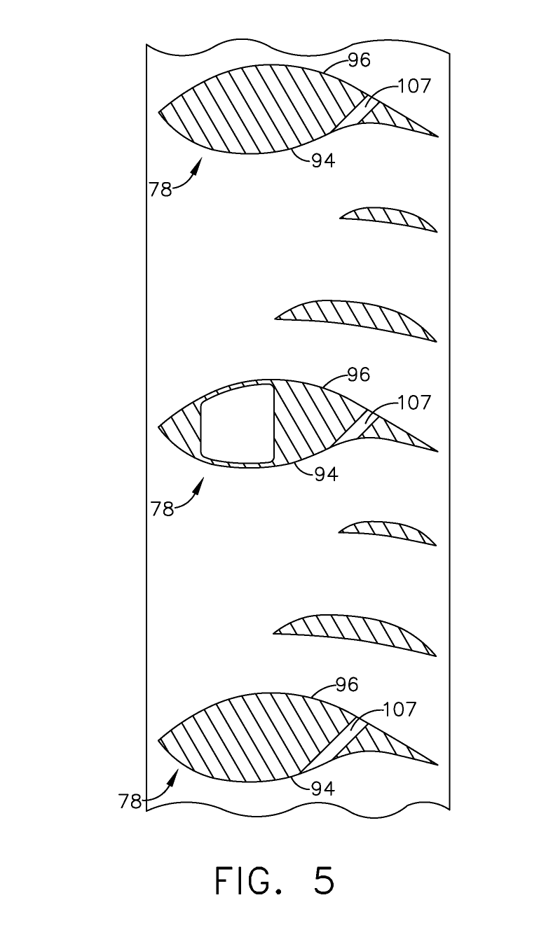

Optionally, at least some of the first vanes 78 may incorporate a slotted configuration. This variation is shown in FIG. 5 where first vanes 78 are shown with slots 107 disposed in the aft half thereof, passing through the vane thickness to interconnect the pressure side 94 and the suction side 96. In operation, the slots 107 allow air flow to pass between the pressure side 94 and the suction side 96. The slots may permit more aggressive flow turning while avoiding undesired effects such as flow separation.

Each of the second vanes 80 extends from a root 108 at the inner flowpath surface 72 to a tip 110 at the outer flowpath surface 76, and includes a concave pressure side 112 joined to a convex suction side 114 at a leading edge 116 and a trailing edge 118.

Each of the second vanes 80 has a span (or span dimension) “S2” (FIG. 3) defined as the radial distance from the root 108 to the tip 110. Depending on the specific design of the second vanes 80, its span S2 may be different at different axial locations. For reference purposes, the relevant measurement would be the span S2 at the leading edge 116. Each second vane 80 has a chord (or chord dimension) “C2” (FIG. 4) defined as the length of an imaginary straight line connecting the leading edge 116 and the trailing edge 118. Depending on the specific design of the second vanes 80, their chord C2 may be different at different locations along the span S2. For purposes of the present invention, the relevant measurement would be the chord C1 at the root 108 or tip 110. Each of the second vanes 80 has a thickness “T2” (FIG. 4) defined as the distance between the pressure side 112 and the suction side 114. A “thickness ratio” of the second vane 80 is defined as the maximum value of the thickness T2, divided by the chord length, expressed as a percentage.

The span S2 and/or the chord C2 of the second vanes 80 may be some fraction less than unity of the corresponding span S1 and chord C1 of the first vanes 78. These may be referred to as “part-span” and/or “part-chord” vanes. For example, the span S2 may be equal to or less than the span S1. Preferably for reducing blockage and frictional losses, the span S2 is 50% or less of the span S1. As another example, the chord C2 may be equal to or less than the chord C1. Preferably for reducing blockage and frictional losses, the chord C2 is 50% or less of the chord C1. In cases where the second vanes 80 are part-span vanes, they may extend either from the inner band 70 or the outer band 74, or both.

The thickness of the second vanes 80 should be as small as possible consistent with structural, thermal, and aeroelastic considerations. Generally the second vanes 80 may have a thickness ratio less than a thickness ratio of the first vanes 78. As one example, the second vanes 80 may have a thickness ratio of about 10%.

Each of the third vanes 82 extends from a root 120 at the inner flowpath surface 72 to a tip 122 at the outer flowpath surface 76, and includes a concave pressure side 124 joined to a convex suction side 126 at a leading edge 128 and a trailing edge 130.

Each of the third vanes 82 has a span (or span dimension) “S3” (FIG. 3) defined as the radial distance from the root 120 to the tip 122. Depending on the specific design of the third vanes 82, its span S3 may be different at different axial locations. For reference purposes, the relevant measurement would be the span S3 at the leading edge 128. Each third vane 82 has a chord (or chord dimension) “C3” (FIG. 4) defined as the length of an imaginary straight line connecting the leading edge 128 and the trailing edge 130. Depending on the specific design of the third vane 82, its chord C3 may be different at different locations along the span S3. For purposes of the present invention, the relevant measurement would be the chord C3 at the root 120 or tip 122. Each of the third vanes 82 has a thickness “T3” (FIG. 4) defined as the distance between the pressure side 124 and the suction side 126. A “thickness ratio” of the third vane 82 is defined as the maximum value of the thickness T3, divided by the chord length, expressed as a percentage.

The span S3 and/or the chord C3 of the third vanes 82 may be some fraction less than unity of the corresponding span S1 and chord C1 of the first vanes 78. These may be referred to as “part-span” and/or “part-chord” vanes. For example, the span S3 may be equal to or less than the span S1. Preferably for reducing blockage and frictional losses, the span S3 is 50% or less of the span S1. As another example, the chord C2 may be equal to or less than the chord C1. Preferably for reducing blockage and frictional losses, the chord C3 is 50% or less of the chord C1. In cases where the third vanes 82 are part-span vanes, they may extend either from the inner band 70 or the outer band 74, or both.

The thickness of the third vanes 82 should be as small as possible consistent with structural, thermal, and aeroelastic considerations. Generally the third vanes 82 may have a thickness ratio less than a thickness ratio of the first vanes 78. As one example, the third vanes 82 may have a thickness ratio of about 10%.

The vanes may be configured with a variable chord, that is, the relevant chord lengths of the vanes may be different from each other (i.e. the chord may vary from vane to vane). In one embodiment the individual vanes within the array of vanes may have at least three different chord lengths. For example in FIG. 4 the chord lengths C1, C2, and C3 are all different. As shown in the illustrated example, the vanes may be configured in a “cascading” arrangement with the chord of the first vanes 78 being the largest, the chord of the second vanes 80 (closest to the suction side 96 of the adjacent first vane 78) being smaller than the chord of the first vanes 78, and the chord of the third vanes 82 (closest to the pressure side 94 of the adjacent first vane 78) being the smallest. The plurality of vanes can be preferentially sized to achieve the desired flow turning while minimizing flow blockage and friction losses. A similar arrangement of variable or cascading chord length may be implemented with any number of vanes or groups of vanes. Furthermore, the arrangement of vanes need not be uniform around the circumference of the turbine vane frame 36.

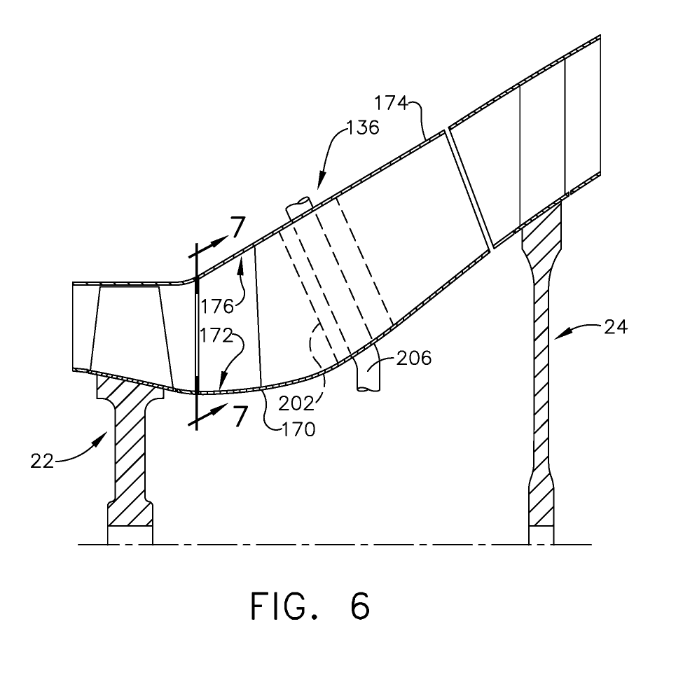

FIGS. 6, 7, and 8 illustrate an alternative embodiment of a turbine vane frame 136, along with portions of the high pressure turbine 22 and the low pressure turbine 24.

The turbine vane frame 136 includes an annular inner band 170 that defines an annular inner flowpath surface 172, and an annular outer band 174 that surrounds the inner band 170 and defines an annular outer flowpath surface 176.

An array of stationary airfoil-shaped turning vanes (or simply “vanes”) extend between the inner band 170 and the outer band 174. In the illustrated example, the vanes are of two distinct configurations referred to respectively as first vanes 178 and second vanes 180. The complete array of turning vanes comprises a repeating pattern of the first and second vanes around the periphery of the turbine vane frame 136. The structural aspects of each of the discrete vane configurations will be described in further detail below.

Similar to the turbine vane frame 36 described above, the first and second vanes 178, 180 are configured to produce a particular degree of turning of the flow in the tangential direction as required by the aerodynamic design of the engine 10. The turbine vane frame 136 is configured so as to produce a high degree of flow turning as defined above.

Each of the first vanes 178 extends from a root 190 at the inner flowpath surface 172 to a tip 192 at the outer flowpath surface 176, and includes a concave pressure side 194 joined to a convex suction side 196 at a leading edge 198 and a trailing edge 200.

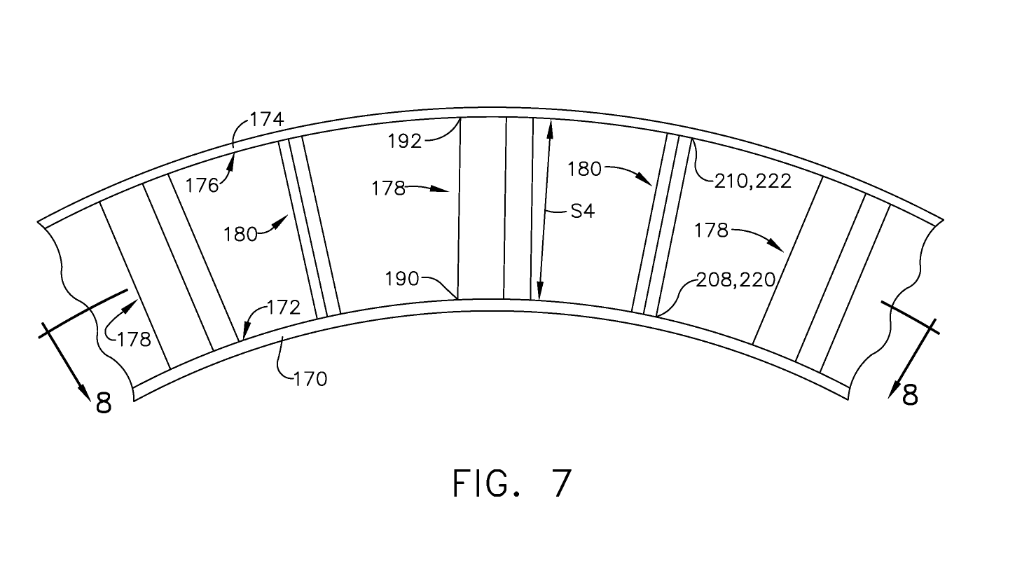

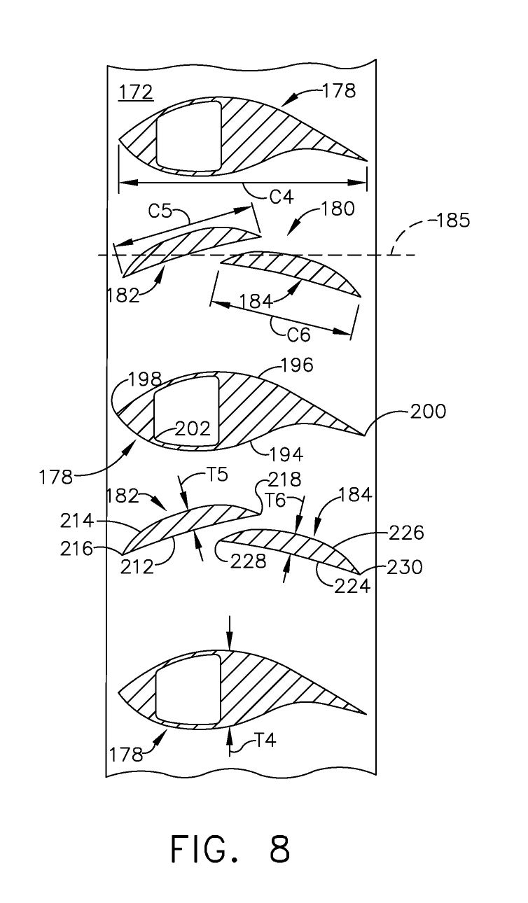

Each of the first vanes 178 has a span (or span dimension) “S4” (FIG. 7) defined as the radial distance from the root 190 to the tip 192. Depending on the specific design of the first vanes 178, its span S4 may be different at different axial locations. For reference purposes, the relevant measurement would be the span S4 at the leading edge 198. Each first vane 178 has a chord (or chord dimension) “C4” (FIG. 8). Depending on the specific design of the first vanes 178, its chord C4 may be different at different locations along the span S1. For purposes of the present invention, the relevant measurement would be the chord C4 at the root 190 or tip 192.

Each of the first vanes 178 has a thickness “T4” defined as the distance between the pressure side 194 and the suction side 196 (see FIG. 8). In addition to serving as aerodynamic turning elements, the first vanes 178 are sized and configured so as to support structural loads applied to the turbine vane frame 136 during engine operation. The first vanes 178 are also sized to serve as pass-through elements as described below. In order to serve these functions, the first vanes 178 may have a significant thickness over and above that required for flow turning purposes. For example, the first vanes 178 may be about 30% to 40% thick.

At least some of the first vanes 178 may incorporate a hollow interior cavity 202. The function of this interior cavity 202 is to allow one or more service tubes to pass therethrough, as described above for first vanes 78. An exemplary service tube 206 is shown schematically in FIG. 6.

Each of the second vanes 180 comprises a pair of airfoils, referred to herein as a “forward airfoil” 182 and an “aft airfoil” 184, positioned in close proximity to each other in a tandem configuration. The term “tandem” as used herein refers to two objects being positioned at least partially one ahead of the other in an axial direction. A key feature of a tandem relationship is that the two objects overlap in the tangential direction. For example, it can be seen in FIG. 8 that an axial line 185 (representing a single tangential location) may be drawn passing through both the forward airfoil 182 and the aft airfoil 184. A tandem configuration improves boundary layer control relative to single-airfoil configurations for vanes with high turning and high loading. The risk of flow separation is mitigated as a new boundary layer grows on the aft airfoil 184 of the two tandem airfoils while in a single-airfoil configuration, the pressure rise along the vane surface may be large enough for a local flow separation towards the vane trailing edge. Overall, under certain flow conditions, the tandem vane concept may thus lead to aerodynamic performance benefits.

Each of the forward airfoils 182 extends from a root 208 at the inner flowpath surface 172 to a tip 210 at the outer flowpath surface 176, and includes a concave pressure side 212 joined to a convex suction side 214 at a leading edge 216 and a trailing edge 218.

Each of the forward airfoils 182 has a chord (or chord dimension) “C5” (FIG. 8). Depending on the specific design of the forward airfoils 182, its chord C5 may be different at different locations along its span. For purposes of the present invention, the relevant measurement would be the chord C5 at the root 208 or tip 210. Each of the forward airfoils 182 has a thickness “T5” (FIG. 8) defined as the distance between the pressure side 212 and the suction side 214.

Each of the aft airfoils 184 extends from a root 220 at the inner flowpath surface 172 to a tip 222 at the outer flowpath surface 176, and includes a concave pressure side 224 joined to a convex suction side 226 at a leading edge 228 and a trailing edge 230.

Each of the aft airfoils 184 has a chord (or chord dimension) “C6” (FIG. 8) Depending on the specific design of the aft airfoils 184, its chord C6 may be different at different locations along its span. For purposes of the present invention, the relevant measurement would be the chord C6 at the root 220 or tip 222. Each of the aft airfoils 184 has a thickness “T6” (FIG. 8) defined as the distance between the pressure side 224 and the suction side 226.

The thickness of the forward and aft airfoils 182 and 184 should be as small as possible consistent with structural, thermal, and aeroelastic considerations. Generally the forward and aft airfoils 182 and 184 may have a thickness ratio less than a thickness ratio of the first vanes 178. As one example, the forward and aft airfoils 182 and 184 may have a thickness ratio of about 10%.

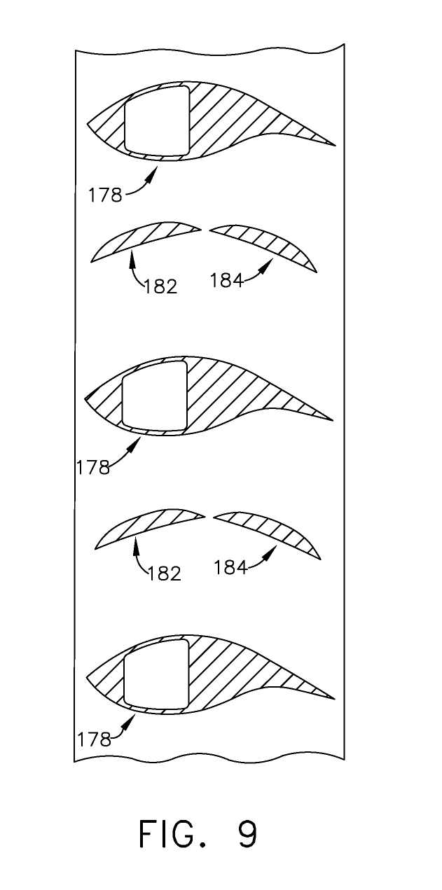

Generally, the chords C5 and C6 of the forward and aft airfoils 182 and 184 would be less than the chord C4 of the first vanes 178. Various configurations are possible of the forward and aft airfoils 182, 184. For example, the chords C5 and C6 may be equal to each other or different. Furthermore, the forward and aft airfoils 182, 184 may be overlapping or non-overlapping in the streamwise or axial direction. FIG. 8 illustrates a configuration in which the forward and aft airfoils 182, 184 overlap in the streamwise or axial direction. FIG. 9 illustrates an alternative configuration in which there is no overlap in the streamwise or axial direction.

As seen in FIGS. 1-9, the inner and outer flowpath surfaces are depicted as bodies of revolution (i.e. axisymmetric structures). Optionally, either or both of the inner or outer flowpath surfaces may incorporate a non-axisymmetric surface profile. More specifically, either or both of the inner or outer flowpath surfaces may have a surface profile with a combination of peaks and troughs determined through the application of 3-D computational fluid dynamics (“CFD”) software. This may be referred to as “3-D aero” design.

For example, FIGS. 10-14 illustrate an alternative embodiment of a turbine vane frame 336. The turbine vane frame 336 includes an annular inner band 370 that defines an annular inner flowpath surface 372, and an annular outer band 374 that surrounds the inner band 370 and defines an annular outer flowpath surface 376.

An array of stationary airfoil-shaped turning vanes (or simply “vanes”) extend between the inner band 370 and the outer band 374. In the illustrated example, the vanes are of three distinct configurations referred to respectively as first vanes 378, second vanes 380, and third vanes 382. The complete array of turning vanes comprises a repeating pattern of the first, second, and third vanes around the periphery of the turbine vane frame 336. The structural aspects of the vanes may be the same as any of the vane embodiments described above.

In the illustrated example, the inner band 370 incorporates a non-axisymmetric surface profile comprising one or more regions which protrude relatively further into the primary flowpath compared to a nominal axisymmetric profile (illustrated by a dashed line) and one or more regions which are recessed away from the primary flowpath compared to a nominal axisymmetric profile. These may be referred to as “peaks” (shown at arrows 384) and “valleys” (shown at arrows 386), respectively. The peaks 384 represent areas of relatively larger radius of the inner band 370 as measured from the axis 11 (FIG. 1). Areas having a relatively larger radius will have a smaller flow area past the vanes, and thus a higher velocity. The valleys 386 represent areas of relatively lower radius of the inner band 370 as measured from the axis 11. Areas having a relatively lower radius will have a greater flow area past the vanes and thus a lower velocity. Another way of describing this flowpath contouring is that the inner band 370 (or the outer band 374) has a surface profile incorporating regions of both convex curvature and concave curvature. It is noted that the 3-D contouring may incorporate convex and/or concave curves in both the axial and tangential directions.

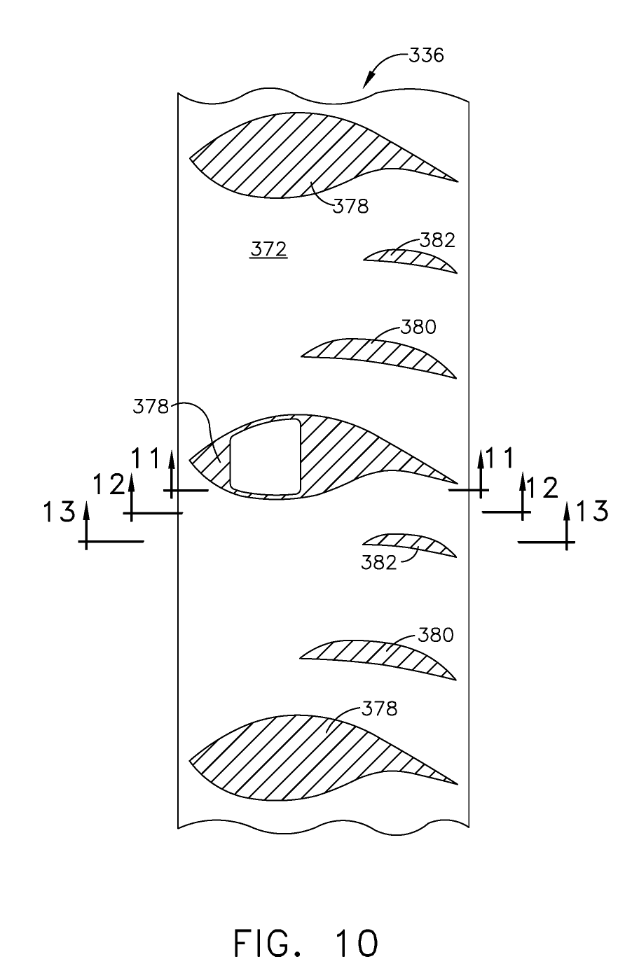

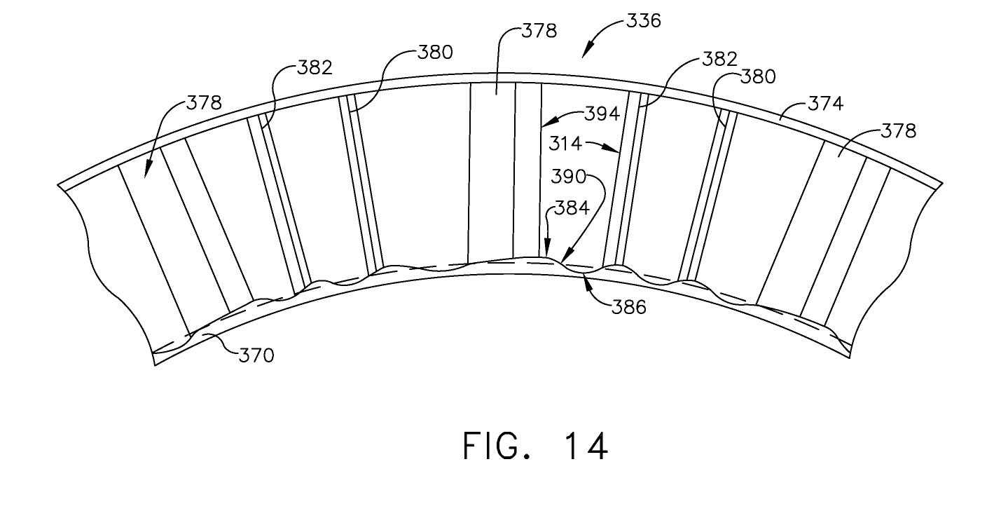

The 3-D contouring may be varied as required to suit a particular application. In one example, seen in FIGS. 11-14, the inner band 370 may incorporate valleys 386 for local velocity relief, that is, lowering local fluid velocity so as to avoid effects such as locally supersonic flow, that would cause compression shocks downstream of turbine vane frame 336 and high flow losses. Taking one of the first vanes 378 as an example, a valley 386 may be disposed between the pressure side 394 of the first vane 378 and the suction side 314 of the adjacent third vane 382, approximately midway circumferentially between the two airfoils. This is seen in FIGS. 13 and 14. This valley 386 provides local velocity relief.

Continuing with this example, a peak 384 may be disposed adjacent the pressure side 394 of the first vane 378 (intersecting the root of the first vane 378). This is seen in FIGS. 11 and 14. The presence of the peak 384 may serve to partially or completely offset the presence of the valley 386, for the purpose of maintaining a predetermined total flow area between the first vane 378 and the third vane 382.

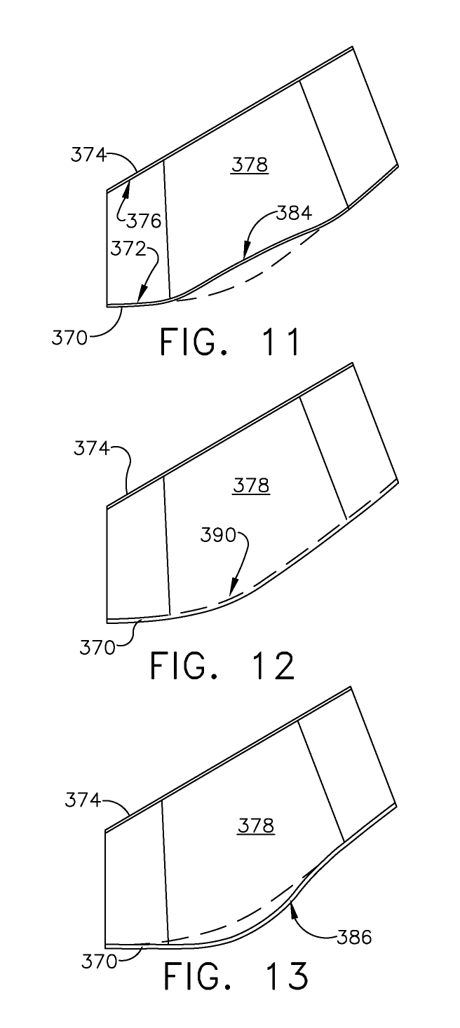

The valley 386 and the peak 384 may be smoothly interconnected by a transition portion 390 which circumferentially is disposed between the valley 386 and the peak 384 which radially passes through the nominal profile. This is seen in FIGS. 12 and 14.

A similar contouring pattern of valleys, peaks, and transition portions may be used around each of the first, second, and third vanes 378, 380, 382.

The turbine vane frame described herein includes turning vanes of different individual chord and pitch (as opposed to constant chord described in prior art). The largest of these vanes with the highest airfoil thickness may be used to house structural and piping components, while the shorter turning vanes may serve as aerodynamic elements to more efficiently turn the flow and provide an optimum inflow to the first stage low-pressure turbine rotor which is characterized by high uniformity of total pressure, total temperature, Mach number, and flow angle. The vanes may include a highly three-dimensional geometric design for reduced wetted surface and increased suction side solidity.

The turbine frame apparatus described herein has advantages over prior art designs. In particular, the features described herein serve to reduce aerodynamic losses and enhance flow uniformity at the turbine vane frame exit, thus benefiting both component and system performance.

The foregoing has described a turbine vane frame apparatus. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A turbine vane frame apparatus comprising:
an annular inner band disposed about a centerline axis and defining an inner flowpath surface;
an annular outer band surrounding the inner band and defining an outer flowpath surface; and
an array of axial-flow airfoil-shaped vanes disposed between the inner and outer flowpath surfaces, wherein the vanes have at least three different chord dimensions.

2. The apparatus of claim 1 wherein the vanes are arranged in repeating groups around the periphery of the apparatus.

3. The apparatus of claim 2 wherein the vanes in each group have a cascading chord length.

4. The apparatus of claim 1 wherein the array of vanes includes:
a plurality of first vanes having a first thickness ratio; and
a plurality of second vanes having a second thickness ratio which is less than the first thickness ratio.

5. The apparatus of claim 4 wherein the thickness ratio of the first vanes is approximately 30% to 40%.

6. The apparatus of claim 4 wherein the thickness ratio of the second vanes is approximately 10%.

7. The apparatus of claim 4 wherein a chord dimension of the second vanes is 50% or less of a chord dimension of the first vanes.

8. The apparatus of claim 4 wherein a span dimension of the second vanes is less than a span dimension of the first vanes.

9. The apparatus of claim 8 wherein the span dimension of the second vanes is 50% or less of the span dimension of the first vanes.

10. The apparatus of claim 8 wherein the second vanes extend from both the inner and outer flowpath surfaces.

11. The apparatus of claim 4 wherein one or more of the first vanes defines a hollow interior cavity therein.

12. The apparatus of claim 11 further including at least one service tube passing through the hollow interior cavity.

13. The apparatus of claim 1 wherein at least some of the vanes incorporate slots passing therethrough.

14. The apparatus of claim 1 wherein some of the vanes are configured as single airfoils and some of the vanes are configured as pairs of tandem airfoils.

15. The apparatus of claim 1 further comprising:
a first turbine including a first rotor disk carrying an array of first turbine blades disposed upstream of the turbine vane frame; and
a second turbine including a second rotor disk carrying an array of second turbine blades disposed downstream of the turbine frame.

16. The apparatus of claim 15 wherein the second rotor disk is positioned immediately downstream of the turbine vane frame, with no turbine nozzle being interposed therebetween.

17. The apparatus of claim 1 wherein the vanes are configured to turn a fluid flow passing therethrough through an angle of at least 50° in a tangential direction.

18. The apparatus of claim 17 wherein the vanes of configured to turn a fluid flow passing therethrough through an angle of 50° to 70° in a tangential direction.

19. The apparatus of claim 1 wherein at least one of the inner and outer flowpath surfaces is not a body of revolution.

20. The apparatus of claim 19 wherein at least one of the inner and outer flowpath surfaces includes at least one region of convex curvature and at least one region of concave curvature.

21. The apparatus of claim 19 wherein at least one of the inner and outer flowpath surfaces includes a valley disposed circumferentially between adjacent ones of the vanes.

22. The apparatus of claim 21 wherein at least one of the inner and outer flowpath surfaces includes a peak disposed circumferentially adjacent to one of the vanes.

23. The apparatus of claim 22 wherein at least one of the inner and outer flowpath surfaces includes a transition portion disposed circumferentially between the peak and the valley.

24. A turbine vane frame apparatus comprising:
an annular inner band disposed about a centerline axis and defining an inner flowpath surface;
an annular outer band surrounding the inner band and defining an outer flowpath surface; and
an array of axial-flow airfoil-shaped vanes disposed between the inner and outer flowpath surfaces, wherein some of the vanes are configured as single airfoils and some of the vanes are configured as pairs of tandem airfoils.

25. The apparatus of claim 24 wherein the vanes are arranged in repeating groups around the periphery of the apparatus.

26. The apparatus of claim 24 wherein the array of vanes includes:
a plurality of first vanes having a first thickness ratio; and
a plurality of second vanes having a second thickness ratio which is less than the first thickness ratio.

27. The apparatus of claim 26 wherein one or more of the first vanes defines a hollow interior cavity therein.

28. The apparatus of claim 24 wherein the vanes are configured to turn a fluid flow passing therethrough through an angle of at least 50° in a tangential direction.

29. The apparatus of claim 24 wherein at least one of the inner and outer flowpath surfaces is not a body of revolution, and includes at least one region of convex curvature and at least one region of concave curvature.
